(19) United States
(12) Patent Application Publication
(10) Pub. No.: US 2016/0062333 A1
(43) Pub. Date: Mar. 3, 2016

(54) PHYSICAL INTERACTIONS THROUGH INFORMATION INFRASTRUCTURES INTEGRATED IN FABRICS AND GARMENTS

(71) Applicant: Georgia Tech Research Corporation, Atlanta, GA (US)

(72) Inventor: Sundaresan Jayaraman, Atlanta, GA (US)

(21) Appl. No.: 14/839,475

(22) Filed: Aug. 28, 2015

Related U.S. Application Data
(60) Provisional application No. 62/042,991, filed on Aug. 28, 2014.

(51) Int. Cl. G05B 19/042; G08C 17/02; G05B 19/406; A41D 1/00

(52) U.S. Cl. CPC G05B 19/042; A41D 1/005; G08C 17/02; G05B 19/406; G05B 2219/21102; G05B 2219/40625

(57) ABSTRACT

Various apparatus, systems and methods are provided for physical interactions through information infrastructures integrated in fabrics and garments. In one example, among others, a system includes garments (or wearables) having integrated information infrastructure including sensors and/or actuation devices distributed about the garments. A first garment can be configured to transmit sensor information corresponding to a physical stimulation experienced by a first wearer of the first garment and a second garment can be configured to receive the sensor information and control the actuation devices to provide a corresponding physical stimulation to a second wearer of the second garment. In another example, a method includes receiving sensor information corresponding to a physical interaction sensed by another garment and controlling an actuation device to provide a corresponding physical stimulation to a wearer of this garment. Tactile communication is possible though a garment based upon the physical stimulations produced by the worn garment.

### CROSS REFERENCE TO RELATED APPLICATIONS

This application claims priority to, and the benefit of, co-pending U.S. provisional application entitled “Sportataiment: The Technology and Business of Experiencing Sports” having Ser. No. 62/042,991, filed Aug. 28, 2014, which is hereby incorporated by reference in its entirety.

### BACKGROUND

Mobile smartphone technology has helped to make the paradigm of “Information Anywhere, Anytime, Anyone” a reality by facilitating the dissemination of both visual and audio information. For instance, it is possible for a racing car enthusiast in Cupertino, Calif. to see—on his mobile device—the driver's view of the track as he negotiates the Daytona Speedway. In addition, the enthusiast can instantaneously access all the “stats” associated with the lap, the race, the standings, the history and so on, thanks to the convergence of high performance computing, communications, video and data fusion technologies. However, the fan cannot “feel” what the driver is experiencing.

### SUMMARY

Disclosed are various embodiments for physical interactions through information infrastructures integrated in fabrics and garments. In one or more aspects a system is provided utilizing garments (or wearables) having integrated information infrastructure including sensors and/or actuation devices distributed about the garments. In one or more aspects, physical interactions can be carried out between associated wearers of the garments through the integrated information infrastructures. Sensors can detect physical stimulations experienced by a wearer of one garment and communicate the sensor information to another garment, where actuators can produce a corresponding physical stimulation for the individual wearing the other garment. In this way, physical interactions experienced by one individual can be felt by another individual. For example, a fan watching a sporting event can “feel” the forces experienced by an athlete during the event. In some implementations, two-way communications can be carried out between two or more individuals through physical interactions that are facilitated through the garments. The sensor information can also be communicated to a remotely located center (e.g., for monitoring or command and control), which may provide feedback through the garment. Other applications are also possible as will be or become apparent to one with skill in the art upon examination of the following drawings and detailed description.

In an embodiment, a system is provided that comprises a plurality of garments having integrated information infrastructures including a plurality of sensors and/or a plurality of actuation devices distributed about the garments. A first garment can be configured to transmit sensor information corresponding to a physical stimulation experienced by a wearer of the first garment and a second garment can be configured to receive the sensor information from the first garment and control the plurality of actuation devices to provide a corresponding physical stimulation to a wearer of the second garment.

In another embodiment, a method is provided that comprises receiving, by a first garment having an integrated information infrastructure, sensor information received from a second garment having an integrated information infrastructure including a plurality of sensors. The sensor information can correspond to a physical interaction sensed by at least a portion of the plurality of sensors. The method further comprises controlling one or more actuation device distributed about the first garment to provide a corresponding physical stimulation to a wearer of the first garment.

In any one or more aspects of the system or the method, a smart mobile communications device can receive the sensor information and transmit the sensor information to another garment via a wireless link. The smart mobile communications device can receive the sensor information from another smart mobile communications device in communication with the garment providing the sensor information. Other systems, methods, features, and advantages of the present disclosure for a reservoir forecasting application, will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of an individual physically interacting through a garment (or wearable) having an integrated information infrastructure including sensors and/or actuators in accordance with various embodiments of the present disclosure.

FIG. 2 illustrates examples of individuals who can physically interact through a wearable in accordance with various embodiments of the present disclosure.

FIG. 3 illustrates an example of unit operations associated with obtaining and processing situational data using a wearable in accordance with various embodiments of the present disclosure.

FIG. 4 illustrates various characteristics of a wearable in accordance with various embodiments of the present disclosure.

FIG. 5 includes images of examples of infant and adult wearables in accordance with various embodiments of the present disclosure.

FIG. 6 is a graphical representation of an example of the architecture of an integrated information infrastructure of a wearable in accordance with various embodiments of the present disclosure.

FIG. 7 illustrates an example of the information infrastructure of FIG. 6 fashioned into a wearable garment in accordance with various embodiments of the present disclosure.

FIGS. 8A and 8B illustrate an example of sensor and actuator distribution and conductive fiber interconnection in the information infrastructures of FIGS. 6 and 7 in accordance with various embodiments of the present disclosure.

FIG. 9 illustrates an example of the information infrastructures of FIGS. 6 and 7 including one or more multi-functional processor and transceiver in accordance with various embodiments of the present disclosure.

FIG. 10 is a graphical representation of a system for communication of physical interactions of wearers of the wearable having the information infrastructures of FIGS. 6-9 in accordance with various embodiments of the present disclosure.

### DETAILED DESCRIPTION

Disclosed herein are various embodiments of garments or other wearables, systems and methods related to physical interactions through information infrastructures integrated in fabrics and garments. Reference will now be made in detail to the description of the embodiments as illustrated in the drawings, wherein like reference numbers indicate like parts throughout the several views.

Wearables include garments or other clothing made of fabric including information infrastructures such as, e.g., a smart garment worn by a runner to track and monitor his steps or other vital signs. Such functional wearables can be characterized as mobile information processing—whether it is a gamer shooting at a target that is also being simultaneously chased by a fellow gamer on the other side of the world, a cyclist's trainer ensuring that the rider is maintaining proper posture on the curve, or a runner tracking his workout for the day. Wearables can be configured for mobile information processing for specific applications such as immersive gaming, fitness, public safety, entertainment, healthcare, etc.

The functionality of wearables can also include the ability to physically interact with the wearer or between individuals wearing the functionalized garments. Such functionality can be provided by sensors, actuators and/or other devices integrated into the garments or fabric. For example, the racing suit of a driver at the Daytona Speedway can be configured to sense the G-forces acting on different parts of his body during the course of the race. The information infrastructures of the racing suit can also capture biometrics such as, e.g., heart rate, electrocardiogram, body temperature, water loss, and calories burned. The driver's biometric and contextual/experiential data (e.g., G-forces) can be captured through the driver's clothing built with a wearable motherboard (or smart shirt) integrated with pressure and other sensors and/or flexible displays (made with, but not limited to, OLEDs and fiber optics).

These parameters can be communicated for real-time monitoring of the driver by the pit crew, where it can be integrated with the archival data to evaluate when to take the next pit stop and/or what actions to take during the stop. Various parameters may also be provided for display on a fan's mobile device. The physical conditions felt by the driver may also be communicated to the fan through a wearable or other functionalized garment worn by the fan. In this way, the fan in California could physically “experience” the G-forces acting on the driver during the race with varying degrees of compression on his body. This experience can be made possible through clothing with integrated sensors and activation devices. Temperature effects can also be simulated through the wearable.

This information can be wirelessly transmitted from the clothing worn by the driver to the fan via a transceiver such as, e.g., a smartphone or other appropriate wireless communication device. The fan's clothing (which can be referred to as experience wear, or ExpWear for short) will, in turn, interface with another transceiver (e.g. a smartphone) and transform the data to recreate the remote ambient environment so that the fan's clothing (ExpWear) reacts to simulate the conditions experienced by the driver. Thus, the fan also experiences the G-forces experienced by the driver through the suite of sensors, actuators and other devices integrated into the garment. In some implementations, sensors in the ExpWear clothing can be used to capture the fan's own biometrics, which can then be displayed on one or more flexible display (made with, but not limited to, OLEDs and fiber optics) integrated into one part of the garment (e.g., the left sleeve) while the driver's biometrics are displayed on another part (e.g., the right sleeve). In other words, the fan in Cupertino can remotely recreate and experience the ambience in Daytona through his ExpWear clothing.

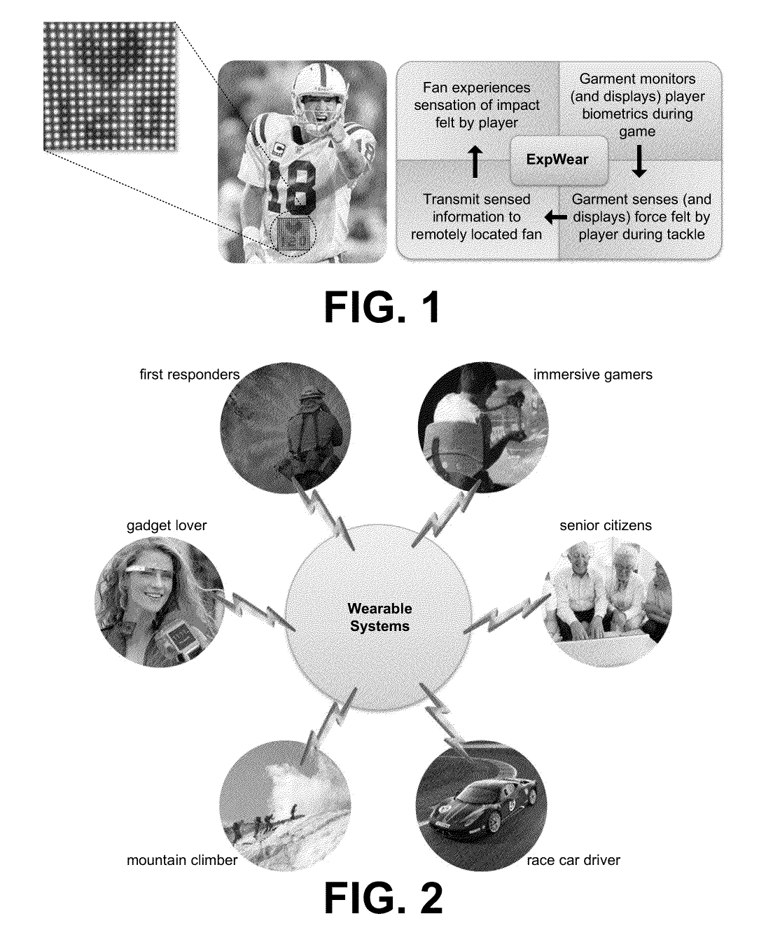

This is the world of sportatainment and represents the integration and transformation of sports actions into entertainment using textiles and clothing along with integrated sensors, actuators and other devices. FIG. 1 illustrates an example of physical sensations felt by one individual being communicated to another individual. Consider a football game where the quarterback (e.g., Peyton Manning) is wearing a smart jersey or other functionalized garment or meta-wearable that can be used to monitor his biometrics (e.g., his heart rate which may be displayed on his smart jersey). With just a few precious minutes left in the game, the quarterback is tackled and the force he experiences is displayed on his Jersey. Immediately, on another continent, a football fan watching the game in his ExpWear clothing experiences the impact of the tackle. Indeed, through the physical interaction produced by actuators in his ExpWear clothing, the fan feels like he is “in the game” thanks to the meta-wearable of textiles and clothing.

Likewise, an avid golf fan can experience a player's swing on the 18th hole in the Masters at Augusta (e.g., Tiger Woods as he attempts to equal Jack Nicklaus's record of most victories there) using ExpWear clothing. With the player wearing a smart garment that senses his movement with its golf-related set of sensors and devices, his swing can be experienced by the fan through the functionalized clothing that he is wearing. Through this enabling technology, the possibilities are limitless. While the sports domain has been chosen as an example, it is easy to visualize transformations in other areas and to see the potential for wearables in other applications.

FIG. 2 illustrates examples of various people such as first responders or other individual operating in hazardous or noisy areas, immersive gamers, senior citizens, athletes (e.g., race car drivers, mountain climbers, etc.) or other sports participants, and gadget lovers; who can physically interact through their personalized wearables. Today's avid gamers want total immersion and expect the gaming experience to be “natural.” They do not want to be constrained by traditional interfaces (e.g., joysticks, keyboards, mice, etc.), but prefer games that let them perform body movements that are realistic. For example, when hitting a ball, players prefer swinging their arm or leg, rather than sliding a mouse or pressing a button. Moreover, wearables enable immersive multi-player games with tangible and physical interaction with the game and the other players.

Wearables can also be used to keep first responders safe and alive by monitoring their physical conditions (e.g., vital signs) and the ambient environment for the presence of dangerous gases and hazardous materials. The sensors can be used to monitor the first responder for physical impacts that can result in injuries and/or immobility of the first responder. This is equally applicable to in home monitoring of senior citizens. The actuators can also be used to communicate with the wearer in situations where the noise level makes it difficult to hear verbal instructions. For example, the actuators can be used to get the attention of the first responder or to indicate a direction of movement (e.g., tap on right or left side).

Wearables can perform the following basic functions or unit operations in the scenarios shown in FIG. 2.
Sense
Process (Analyze)
Store
Transmit
Apply (Utilize)
   The specifics of each function will depend on the application domain and the wearer, and the processing can occur on the individual or can be performed at a remote location (e.g., command and control center for first responders, fans watching the race, or viewers enjoying the mountaineer's view from the Mount Everest base camp).

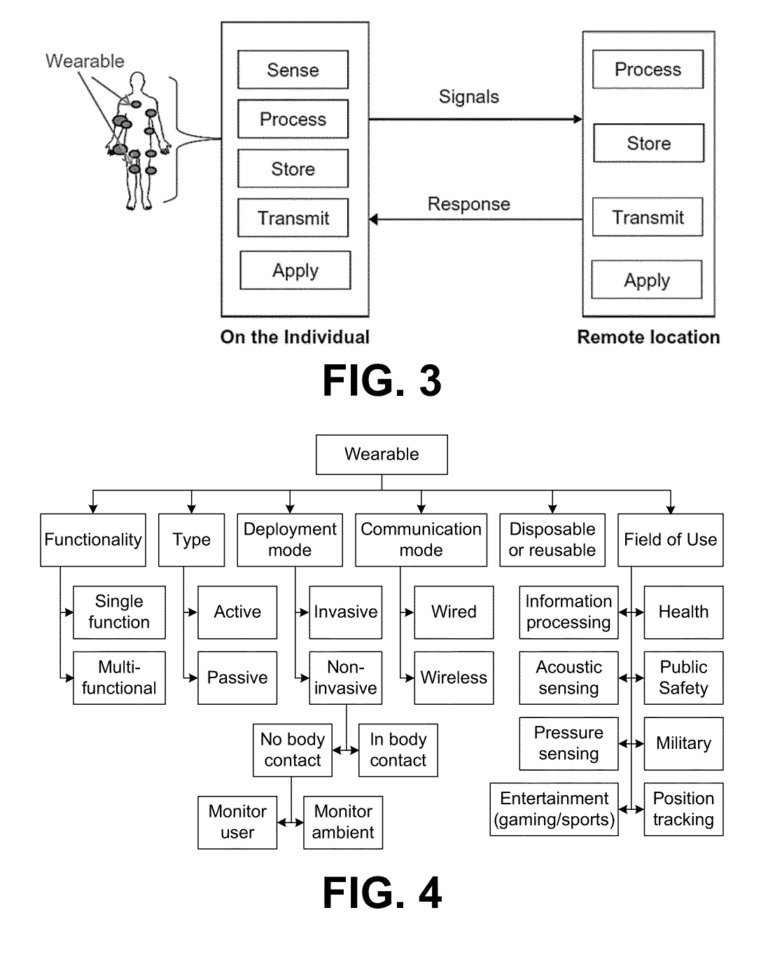

FIG. 3 is a schematic diagram illustrating an example of the unit operations associated with obtaining and processing situational data using wearables. For example, if dangerous gases are detected by a wearable on a first responder, the data can be processed using processing circuitry in the wearable and an alert issued. Simultaneously, indications can be transmitted to a remote location (e.g., a monitoring center) for further processing and/or confirmatory testing. The results—along with any appropriate response (e.g., put on a gas mask)—can be communicated to the wearer in real-time to potentially save a life. This same philosophy can also be used by an avid gamer who might change his strategy depending on what “weapons” are available to him and how his opponents are performing. In addition, physical stimulations (e.g., forces, stress, strain, impacts, temperatures, and/or other types of tactile interactions) can be communicated to the wearer of the smart shirt to provide a more realistic experience. Each of these scenarios can utilize personalized mobile information processing, which can transform the sensory data to information and then to knowledge that will be of value to the individual responding to the situation. Signals can also be sent to other wearables, where they can be transformed into stimulations to physically interact with the wearers.

The advancements in microelectronics, materials, optics, and other bio-technologies have enabled small, cost-effective intelligent sensors and actuators to be developed for a wide variety of applications. These sensors and actuators can be integrated into wearables for collecting information about the wearer and/or their surroundings and communicating and/or stimulating the wearer. Using these sensors and actuators, the wearable can improve the wearer's situational awareness. Smart mobile communications devices such as, e.g., smart-phones and/or tablets can provide a platform for processing information from the wearable and communication of that information to other devices or wearables.

A sensor can be defined as a device used to detect, locate, or quantify energy or matter, giving a signal for the detection of a physical or chemical property to which the device responds. In many ways, human skin can be considered an ultimate sensor or interface. As the largest organ of the human body, it senses, adapts, and responds based on both external and internal stimuli such as heat, cold, fear, pleasure, and pain. In fact, it has the ability to respond to all the five senses of touch, sight, sound, smell, and taste. Human skin can be a powerful and versatile sensor that nature has designed and is akin to an input/output (I/O) device in a computing system. The skin can operate an I/O device that senses and passes the stimulus (or input) to the brain, which interprets the information and allows the individual to react to the situation. This is especially true for tactile stimulations or other physical interactions which can be communicated to the individual through a wearable.

From a physical standpoint, the wearable should be lightweight and have a form factor that is variable to suit the wearer. For instance, consider a wearable to monitor the vital signs of an infant prone to sudden infant death syndrome. If the form factor of the wearable prevents the infant from (physically) lying down properly, it could have significant negative implications. The same would apply to an avid gamer where, if the form factor interferes with her ability to play “naturally,” the less likely that she would be to adopt or use the technology. Aesthetics can also play a role in the acceptance and use of any device or technology. This is especially important when the device is also seen by others (the essence of fashion). Therefore, if the wearable on a user is likely to be visible to others, it should be aesthetically pleasing while meeting its functionality. As wearables become an integral part of everyday life, the acceptance of wearables opens up exciting avenues for research. Ideally, a wearable should become an integral part of the wearer's clothing or accessories that it becomes a “natural” extension of the individual and “disappears” for all purposes. It should also include the flexibility to be shape-conformable to suit the desired end use. In short, it should behave like the human skin when worn.

The wearable can also have multi-functional capabilities and be easily configurable for the desired end-use application. Wearables that monitor more than one parameter are beneficial and can facilitate management of multiple data streams. The wearable's responsiveness is also important for various applications, especially when used for real-time data acquisition and control (e.g., monitoring a first responder in a smoke-filled scene) or providing physical feedback from a game. Therefore, sufficient data bandwidth should be provided to enable the degree of interactivity, which can impact its successful use.

FIG. 4 illustrates various characteristics of wearables. The functionality of the wearable can be classified as single function or multi-functional. They can also be classified as invasive or non-invasive. Invasive wearables (sensors and/or actuators) can be further classified as minimally invasive, such as those that penetrate the skin (subcutaneous) to obtain the signals, or as an implantable, such as a pacemaker. Non-invasive wearables may or may not be in physical contact with the body; the ones not in contact could either be monitoring the individual or the ambient environment (e.g., a camera for capturing the scene around the wearer or a gas sensor for detecting harmful gases in the area). In most applications, non-invasive sensors can be used for continuous monitoring because intervention is usually not needed. In some implementations, a combination of invasive and non-invasive sensors and/or actuators can be used.

Wearables can also be classified as active and/or passive depending upon whether or not they need power to operate. For example, pulse oximetry sensors fall into the active category, while a temperature probe is an example of a passive sensor that does not include its own power to operate. The modes in which the signals are transmitted by the wearable for processing include wired and/or wireless (e.g., cellular, Wi-Fi, Bluetooth®, or other appropriate wireless protocol). In the wired case, the signals can be transmitted over a physical data bus to a processor. While in the wireless class, the communications capability (e.g., transmitter or transceiver) is built into the wearable, which transmits the signals wirelessly to a monitoring unit, receiver or transceiver. Sensors can be configured for a one-time use (disposable) or they can be reusable. In addition, wearables can be classified based on their field of application, which can range from health and wellness monitoring to position tracking as shown in FIG. 4. Information processing can include many traditional functions such as processing e-mail or other wireless communications. Also, functions performed by the wearable may be controlled remotely through data processing and communication.

In many cases, a wearable such as a smart shirt is analogous to a computer motherboard, which provides a physical information infrastructure with data paths into which chips (memory, microprocessor, graphics, etc.) can be incorporated to provide for specific end uses such as gaming, image processing, high-performance computing, etc. Likewise, a wearable motherboard or smart shirt in the form of a fabric or a piece of clothing, can provide an information infrastructure into which the wearer can plug in sensors, actuators and other devices to achieve a wide range of functionality. Such a wearable can provide a flexible information infrastructure to facilitate signal processing, and provide a platform for monitoring the wearer and/or surrounding environment in an efficient and cost-effective manner. Clothing can include “intelligence” embedded into it and spawn the growth of individual networks or personal networks where each garment has its own IN (individual network) address much like today's IP (Internet protocol) address for information-processing devices.

Wearables for personalized mobile information processing can be adapted for various applications. Depending on the use, multiple parameters can be acquired, processed and used to develop an appropriate response. For example, a wearable sensor system can include:
Different types of sensors for simultaneously monitoring various parameters; for instance, sensors of different types can be used to monitor vital signs (e.g., heart rate, body temperature, pulse oximetry, blood glucose level). Likewise, another class of sensors (e.g., carbon monoxide detection) can be included for monitoring hazardous gases. Accelerometers can be utilized to continuously monitor the posture of the gamer or an elderly person and/or detect impacts from falls.
Different numbers of sensors can be included to obtain signals needed to compute a single parameter (e.g., at least three sensors for the computation of an electrocardiogram or EKG).
Sensors and/or actuators that are positioned at different locations on the body to acquire signals for processing and analysis (e.g., sensors for EKG go in three different locations on the body, whereas pulse-ox sensors and accelerometers can be located at one or more other locations on the body) and/or provide different types of physical stimulation.
Different subsets of sensors, actuators and/or other devices for use at different times, which can be attached using fasteners and interfaces designed to allow for easy attachment and removal, or plug and play capabilities. For instance, a gamer or athlete may want to record how his body feels and reacts while being immersed in the game or sporting activity and, at other times, may also want to record the experience.
Signals from various sensors in different physical locations (e.g., first responders responding to a disaster scene) can be sensed, collected, processed, stored, and transmitted to the remote control and coordination location.
Signals from different types of sensors (e.g., body temperature, EKG, accelerometers) can be processed in parallel to evaluate the various parameters in real-time and responses from various actuators can be initiated.
A large number of sensors and/or actuators to fulfill the application needs. The sensors can include low cost devices with minimal built-in (on-board) processing capabilities and should be power-aware with low power requirements.
A power distribution network to supply the various sensors and processors.
   In addition to providing a physical form factor and an integrated information infrastructure, the wearable sensor system can also provide an interface for communication with other wearable devices.

Meta-wearable fabrics can help provide the functionality described above. For instance, textile yarns can serve as data buses or communication pathways for sensors, actuators and processors and can provide the bandwidth for interactivity. The topology, or structure of placement of these data buses, can be engineered to suit the desired sensor surface distribution profile, making it a versatile technology platform for wearables. In addition, textiles and clothing have the following attributes:
In general, no special training is needed to wear the smart shirt or to use the interface.
This functionalize clothing interface can be tailored to fit individual preferences, needs, and tastes, including body dimensions, controls, and applications in which the wearable will be used.
Textiles are flexible, strong, lightweight, and generally withstand different types of operational (e.g., stress/strain) and environmental (e.g., biohazards and climatic) conditions.
Textiles combine strength and flexibility in the same structure, with the ability to conform to the desired shape when bent but retain their strength.
Textiles can have different form factors including dimensions of length, width, and thickness, and hence “variable” surface areas that can be adjusted for hosting varying numbers of sensors and processors for the desired application.
Textiles can provide flexibility in system design through a broad range of fibers, yarns, fabrics, and manufacturing techniques (e.g., weaving, knitting, non-wovens, and printing) that can be deployed to create products with various engineered performance characteristics.
Textiles can be manufactured in a relatively cost-effective (inexpensive) manner.
Since the data buses or communication pathways are an integral part of the fabric, entanglement and snags can be avoided during use.
Textiles can accommodate redundancies in the system by providing multiple communication pathways in the network.
Textile structures can facilitate power distribution from one or more sources through the textile yarns integrated into the fabric, thus minimizing the need for on-board power for the sensors.
   From a technical performance perspective, a textile fabric (or clothing) is a true meta-wearable, making it an excellent platform for the incorporation of sensors, actuators and processors. In addition to one or more processor, the processing circuitry of the information infrastructure can include memory for the storage of data such as sensor information and/or applications that can be executed by the processor to facilitate the functionality of the wearable.

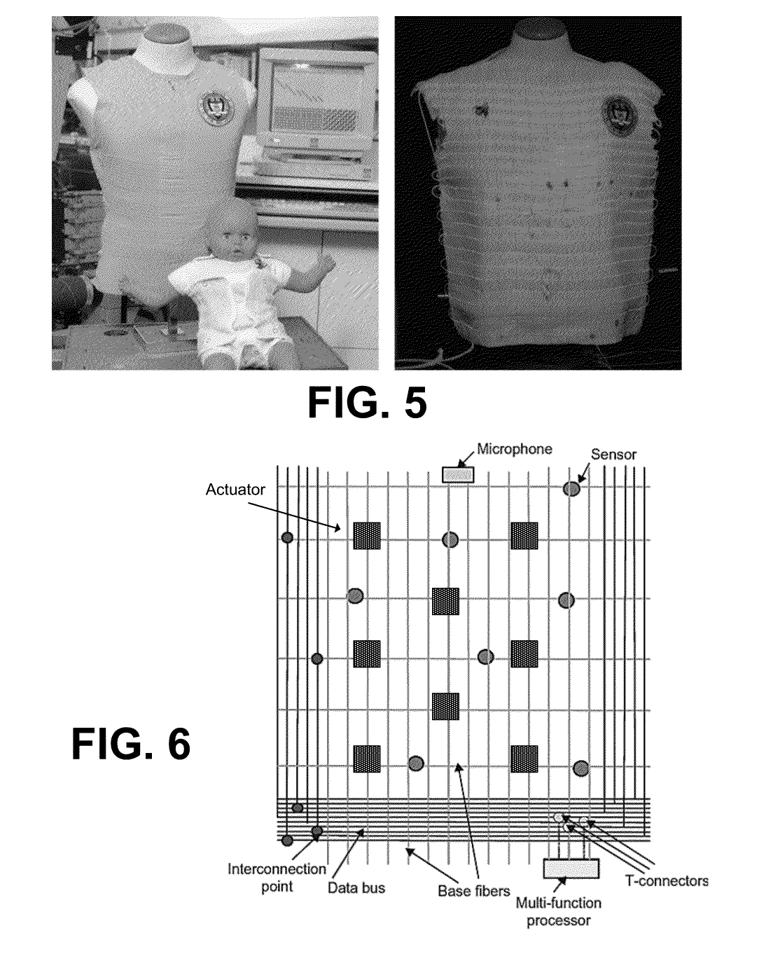

Referring to FIG. 5, shown are images of examples of various wearable motherboards or smart shirts for infants and adults including military versions. A base fabric of the meta-wearable clothing provides the physical infrastructure for the integrated network. The base fabric can be made from typical textile fibers (e.g., cotton and/or polyester) where the choice of fibers is dictated by the intended application. The conducting yarns integrated into the base fabric serve as data buses and/or communication pathways. Interconnections can route the information signals through appropriate paths in the fabric, thereby creating a motherboard that serves as a flexible and wearable framework into which sensors, actuators and other devices can be attached. For instance, vital sign sensors such as, e.g., heart rate, electrocardiogram, and/or body temperature can be used to monitor the wearer's physical condition. In addition, devices such as, e.g., piezoelectric actuators, bi-metallic strips, MEMS devices and/or shape changing fibers can be electrically, thermally and/or optically activated to change shape and provide physical interaction with the wearer.

An example of a wearable motherboard architecture is graphically illustrated in FIG. 5. The signals from the sensors 503 flow through the flexible data bus 506 integrated into the structure to the multi-function processor/controller 509. The controller 509, in turn, processes the signals and transmits them wirelessly (using the appropriate communications protocol) to desired locations (e.g., doctor's office, hospital, battlefield triage station). The bus 512 also serves to transmit information to the sensors 503 and/or actuators 515 (and hence, the wearer) from external sources, thus making the smart shirt a bi-directional information infrastructure. The controller provides the power (energy) to the wearable motherboard. Some or all of the processing and communication can be shifted to a smart mobile communications device such as, e.g., a smart-phone and/or tablet.

The advantage of the motherboard architecture is that the same garment can be reconfigured for a different application by changing the suite of sensors and/or actuators. For example, to detect carbon monoxide or hazardous gases in a disaster zone, special-purpose gas sensors can be used to functionalize the garment, allowing these environmental parameters to be monitored along with the wearer's vital signs. Similarly, by attaching a microphone to the smart shirt, voice and other audio can be recorded and/or transmitted. Conducting fibers in the wearable motherboard can themselves act as “sensors” to capture the wearer's heart rate and EKG (electrocardiogram) or other types of data. Likewise, Optical fibers can be used to detect bullet wounds in addition to monitoring the vital signs of the wearer during combat or other hazardous conditions. In some embodiments, the wearable motherboard can be tailored to be a head cap so that the gamer's brain activity can be tracked by recording the electroencephalogram (EEG). Thus, the wearable motherboard can be a meta-wearable with the structure providing the look and feel of traditional textiles with the fabric serving as a comfortable information infrastructure.

The wearable motherboard provides a platform that enables convergence between electronics and textiles. Because of the modularity of the architecture, the convergence can be controlled by the user. For example, as long as the sensors, actuators and/or processors are plugged into the wearable motherboard, there is convergence and the resulting wearable (in the form of clothing) is smart and can perform its intended function, e.g., monitor the wearer's vital signs or other situational awareness data or providing physical interaction with the wearer. When this task is completed, the sensors, actuators and/or processors can be unplugged and the garment laundered like other clothes. Thus, the usually passive textile structure can be temporally transformed into a smart interactive structure including an information processing structure.

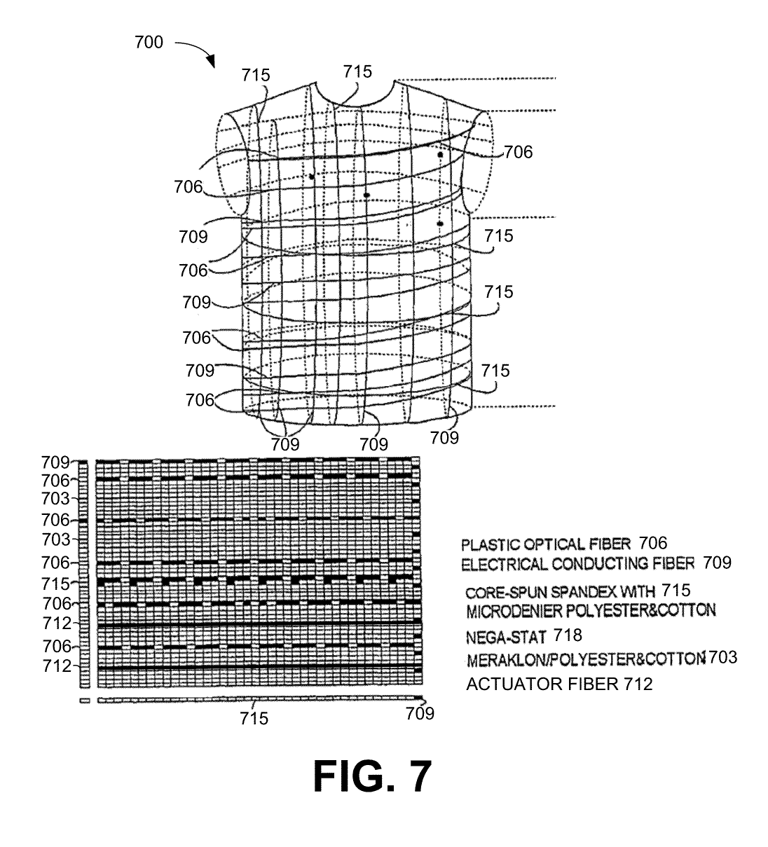

Referring now to FIG. 7, shown is another representative design of a single-piece garment 700, woven similar to a regular sleeveless T-shirt, including bi-directional information infrastructure with a plurality of distributed sensors and actuators. A comfort component 703 provides the base of the fabric and will ordinarily be in immediate contact with the wearer's skin and can provide the comfort properties for the garment 700. Therefore, the chosen material should preferably provide good comfort, fit, air permeability, moisture absorption and stretchability, and should provide at least the same level of comfort and fit as a typical piece of clothing. The comfort component 703 can comprise any yarn used in conventional woven fabrics, and can be determined based upon the application of the fabric and structural characteristics of the yarn. Suitable yarns include, but are not limited to, cotton, polyester/cotton blends, microdenier polyester/cotton blends and polypropylene fibers such as MERAKLON (made by Dawtex Industries).

The information infrastructure component of the fabric can include materials 706 for sensing a penetration of the fabric, or materials 709 for sensing one or more body vital signs, or both. The information infrastructure component can also include materials 712 that can actuate physical stimulation of or interactions with the body of the wearer. These materials can be woven into the fabric during the weaving of the comfort component. After fashioning the fabric into a garment, these materials can be connected to one or more multi-function processor (e.g., a personal status monitor or PSM) which will take indications from the sensing materials 706, process the sensor information, and communicate indications depending upon the sensor information and desired settings for the monitored sensors and/or receive information or indications and initiate physical stimulation and/or interaction with the wearer through the actuator material 712.

Materials 706 suitable for sensing and detection include but are not limited to: silica-based optical fibers, plastic optical fibers, and silicone rubber optical fibers. Suitable optical fibers include those having a filler medium with a bandwidth which can support the desired signal to be transmitted and required data streams. Silica-based optical fibers have been designed for use in high bandwidth, long distance applications. Their extremely small silica core and low numerical aperture (NA) provide a large bandwidth (up to 500 mhz*km) and low attenuation (as low as 0.5 dB/km).

Plastic optical fibers (POFs) provide many of the same advantages that glass fibers do, but at a lower weight and cost. In certain fiber applications, as in some sensors and medical applications, the fiber length used is so short (less than a few meters) that the fiber loss and fiber dispersion are of no concern. Instead, good optical transparency, adequate mechanical strength, and flexibility are the more important properties and plastic or polymer fibers are preferred. Moreover, plastic optical fibers do not splinter like glass fibers and, thus, can be more safely used in the fabric than glass fibers.

For relatively short lengths, POFs have several inherent advantages over glass fibers. POFs exhibit relatively higher numerical aperture (N.A.), which contributes to their capability to deliver more power. In addition, the higher N.A. lowers the susceptibility to light loss caused by bending and flexing of the POF. Transmission in the visible wavelengths range is relatively higher than anywhere else in the spectra. This is an advantage since in most medical sensors the transducers are actuated by wavelengths in the visible range of the optical spectra. Because of the nature of its optical transmission, POF offers similar high bandwidth capability and the same electromagnetic immunity as glass fiber. In addition to being relatively inexpensive, POF can be terminated using a hot plate procedure which melts back the excess fiber to an optical quality end finish. This simple termination combined with the snap-lock design of the POF connection system allows for the termination of a node in under a minute. This translates into extremely low installation costs. Further, POFs can withstand a rougher mechanical treatment displayed in relatively unfriendly environments. Applications demanding inexpensive and durable optical fibers for conducting visible wavelengths over short distances are currently dominated by POFs made of either poly-methyl-methacrylate (PMMA) or styrene-based polymers.

While the POF (706) is shown in FIG. 7 as being in the filling direction of the fabric, the POF can be oriented in other directions. To include the penetration sensing component material into a tubular woven fabric, the material, preferably plastic optical fiber (POF), can be spirally integrated into the structure during a full-fashioned weaving fabric production process as described in U.S. Pat. No. 6,145,551, which is hereby incorporated by reference in its entirety. The POF continues throughout the fabric without discontinuities. This produces a single integrated fabric and no seams are present in the garment.

In some embodiments, the information infrastructure component can include a high or low conductivity fiber electrical conducting material component (ECC) 709. The electrical conductive fiber preferably has a resistivity in a range from about 0.07×10⁻³ to about 10 kohms/cm. The ECC 709 can be used to monitor one or more body vital signs including heart rate, pulse rate and temperature through sensors on the body and for linking to the multi-functional processor (e.g., a PSM). Suitable materials include the three classes of intrinsically conducting polymers, doped inorganic fibers and metallic fibers, respectively.

Polymers that conduct electric currents without the addition of conductive (inorganic) substances comprise intrinsically conductive polymers (ICP). Electrically conducting polymers have a conjugated structure, i.e., alternating single and double bonds between the carbon atoms of the main chain. For example, polyacetylene can be prepared as fibers with a high electrical conductivity, which can be further increased by chemical oxidation. Thereafter, many other polymers with a conjugated (alternating single and double bonds) carbon main chain, e.g, polythiophene and/or polypyrrole, show the same behavior. All intrinsically conductive polymers are insoluble in solvents and possess a very high melting point and exhibit little other softening behavior. Consequently, they cannot be processed in the same way as normal thermoplastic polymers and are usually processed using a variety of dispersion methods.

Another class of conducting fibers 709 includes fibers that are doped with inorganic or metallic particles. The conductivity of these fibers can be quite high if sufficiently doped with metal particles, but this would make the fibers less flexible. Such fibers can be used to carry information from the sensors to the monitoring unit if they are properly insulated.

Metallic fibers, such as copper and/or stainless steel insulated with polyethylene or polyvinyl chloride, can also be used as the conducting fibers 709 in the fabric. With their exceptional current carrying capacity, copper and stainless steel are more efficient than any doped polymeric fibers. The metallic fibers are also strong and resist stretching, neck-down, creep, nicks and breaks very well. Therefore, metallic fibers of very small diameter (of the order of 0.1 mm) will be sufficient to carry information from the sensors to the monitoring unit. Even with insulation, the fiber diameter can be less than 0.3 mm and hence these fibers will be very flexible and can be easily incorporated into the fabric. Also, the installation and connection of metallic fibers to the multi-function processor can be simple. One example of a high conductive yarn suitable for this purpose is BEKINOX available from Bekaert Corporation, Marietta, Ga., which is made up of stainless steel fibers and has a resistivity of 60 ohm-meter. The bending rigidity of this yarn is comparable to that of the polyamide high-resistance yarns and can be easily incorporated into the information infrastructure of the garment.

Thus, electrical conducting materials 709 that can be utilized for the information infrastructure component for the fabric include: (i) doped nylon fibers with conductive inorganic particles and insulated with PVC sheath; (ii) insulated stainless steel fibers; and (iii) thin gauge copper wires with polyethylene sheath. All of these optical and conducting fibers 703 and 706 can readily be incorporated into the fabric and can serve as elements of the wearable motherboard. The fibers 706 and 709 can be incorporated into the woven fabric in two ways: (a) regularly spaced yarns acting as sensing elements; and/or (b) precisely positioned yarns for carrying signals from the sensors to the multi-functional processor. They can be distributed both in the warp and filling directions in the woven fabric. Additionally the fabric/garment including the information infrastructure can be knitted, as opposed to being woven.

The form-fitting component (FFC) 715 provides form-fit to the wearer, which can keep the sensors and actuators in place on the wearer's body during movement. Therefore, the material chosen should have a high degree of stretch to provide the needed form-fit and at the same time, be compatible with the material chosen for the other components of the fabric. One example of a suitable form-fitting component 715 is Spandex fiber, a block polymer with urethane groups. Its elongation, strength and elastic recovery are high, and is resistant to chemicals and withstands repeated machine washings and the action of perspiration. Bands of FFC 715 extending around portions of the garment 700 (e.g., the torso, arms, legs, etc.) behave like “straps”, but are unobtrusive and can be well integrated into the fabric. The FCC 715 allows for normal expansion and contraction of the body, without the need for the wearer to tie something to ensure a good fit for the garment 700.

Actuators can include fibers 712 that change shape or length with thermal, optical or electrical stimulation, piezoelectric devices, and/or other electromechanical devices that can be controlled through the information infrastructure. For example, polymers that change with temperature can be distributed in the woven or knitted fabric similar to the optical, conductive and form-fitting fibers. The actuation fibers 712 can be woven around the torso of the garment or into various sections (e.g., right side, left side, front abdomen, and/or lower back) of the wearer's body. The fibers 709 can contract in response to activation to apply pressure around the torso or on the specific section of the body. For thermal activation, the polymer fiber can include conductive fibers extending through the fiber or can be doped with conductive inorganic particles. Current flow through the fiber can generate heat sufficient to cause the fiber to change shape and apply pressure to the wearer. The fibers will need to be sufficiently insulated to protect the wearer from the applied voltage and generated heat. Other forms of thermal, optical or electrical activation are also possible.

Actuators can also include piezoelectric devices that can be distributed about the garment. For example, the piezoelectric actuator can comprise a thin piezoelectric layer (e.g., foil) that can incorporated in and/or attached to the fabric. Other forms of piezoelectric devices can also be used. Electrical activation of the piezoelectric actuator can cause the device to distort, which can apply localized pressure to the skin of the wearer. The piezoelectric actuators can be positioned in a random or organized fashion (e.g., in an array). Other types of electromechanical actuators (e.g., microelectromechanical systems (MEMS)) can also be included in a similar fashion.

A static dissipating component (SDC) 718 can also be included in the fabric to quickly dissipate static charge that builds up during the use. While it may not be necessary, the SDC 718 can dissipate any generated charge that could damage the sensors, actuators and/or processors. NEGA-STAT is a biocomponent fiber produced by DuPont that can be utilized as the SDC 718. It has a trilobal shaped conductive core that neutralizes the surface charge on the base material by induction and dissipates the charge by air ionization and conduction. An outer shell of polyester or nylon ensures effective wear-life performance with high wash and wear durability and protection against acid and radiation. Other materials which can effectively dissipate the static charge and yet function as a component of a wearable, washable garment may also be used. In the example of FIG. 7, the NEGA-STAT fiber running along the height of the garment, in the warp direction of the fabric, is the SDC 718. The spacing should be adequate for the desired degree of static discharge. For a woven tubular garment, it will ordinarily, but not necessarily, be introduced in the warp direction of the fabric.

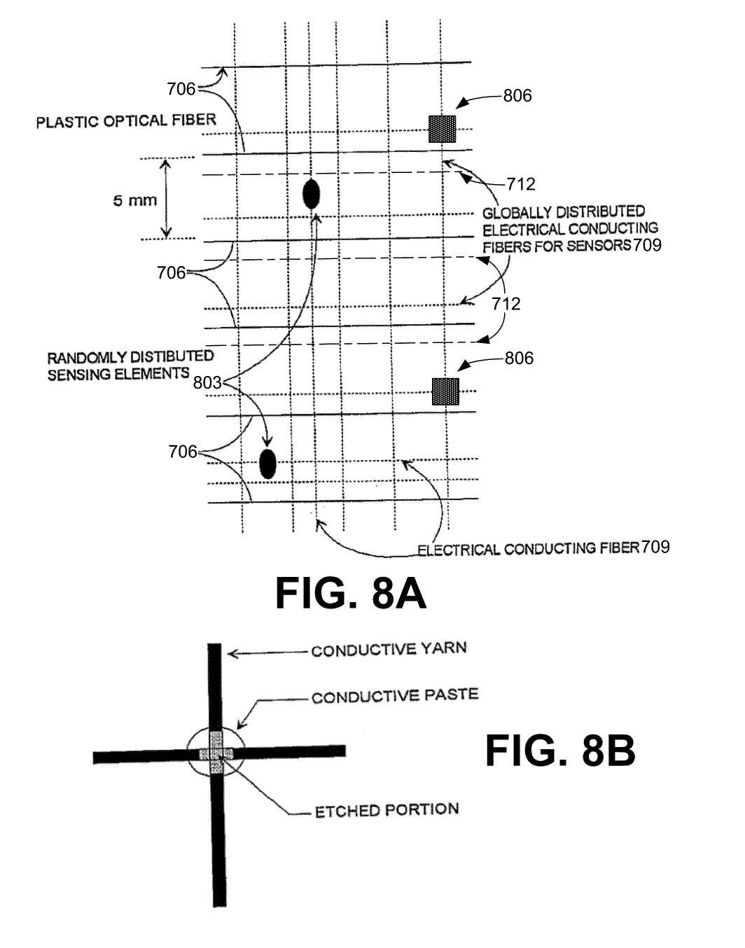

With reference to FIG. 8A, connectors (not shown), such as T-connectors (similar to the “button clips” used in clothing), can be used to connect one or more body sensor 803 and/or one or more microphone (not shown) to the conducting wires 709 that go to the multi-function processor(s). By modularizing the design of the fabric (using the connectors), the sensors 803 can be made independent of the fabric, which can accommodate different body shapes. The connector makes it relatively easy to attach the sensors 803 to the conducting fibers 709. However, it should be recognized that the sensors 803 can also be woven into the structure of the fabric. Similarly, actuators 806 such as piezoelectric or electromechanical devices can be attached to or woven into the fabric. Fabrication of the information infrastructure, including interconnection of fibers and attachment of sensors/actuators is described in U.S. Pat. No. 6,381,482, which is hereby incorporated by reference in its entirety. FIG. 8B illustrates the interconnection of intersecting electrically conductive fibers 709 to which a sensor or actuator can be attached. For example, insulation can be removed by etching and/or mechanical removal. Conductive paste can be used to connect the conductive fibers 709, followed by insulation of the interconnection. T-connectors can be connected to the conductive fiber to allow for attachment of various sensors and/or actuators.

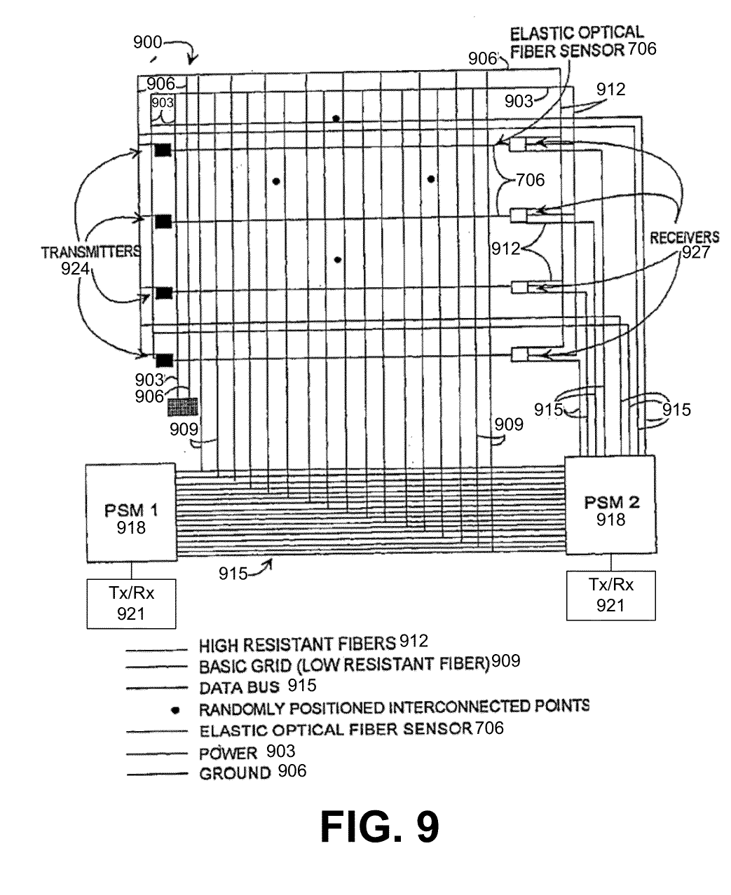

Referring now to FIG. 9, shown is an example of an information infrastructure including two multi-function processors. The circuit diagram of this wearable motherboard 900 (or smart shirt) includes interconnections between a power wire 903 and a ground wire 906 and high 909 and low 912 conducting fibers. The data bus 915 for transferring data from the randomly positioned sensors to the multi-functional processors 918 (e.g., PSM 1 and PSM 2) is also shown. Power can be provided by a power source integrated into the garment (e.g., a battery pack) or through a connection with an external power source. In some embodiments, wireless power transfer may be used to power circuitry, where the secondary circuit can be integrated into the garment.

The processors 918 can be light weight devices that can be located at the hip area of the user (e.g., at the bottom of the garment) and at an end point of the data bus 915. The information obtained by the multi-functional processors 918 can be processed locally and/or transmitted to a remote control center or other wearable (e.g., the medical personnel in the case of military application) through a wireless transmitter or transceiver 921. The transceiver 921 (or transmitter) can be incorporated in the garment and attached to one or more processors 918 or can be externally located from the garment of the user and coupled to the processors 918 using wire conductors (e.g., a plug in connection). The transceivers 921 can be configured for wireless transmission and/or reception of data via, e.g., Bluetooth®, cellular, Wi-Fi or other appropriate wireless communication link.

The elastic motherboard 900 can include modular arrangements and connections for providing power to the electrical conducting material component 709 and for providing a light source for the penetration detection component 706. In one embodiment, the fabric can be made with the sensing component(s) 803 but without inclusion of such power and light sources, or the transmitters 924 and receivers 927 illustrated, expecting such to be separately provided and subsequently connected to the fabric.

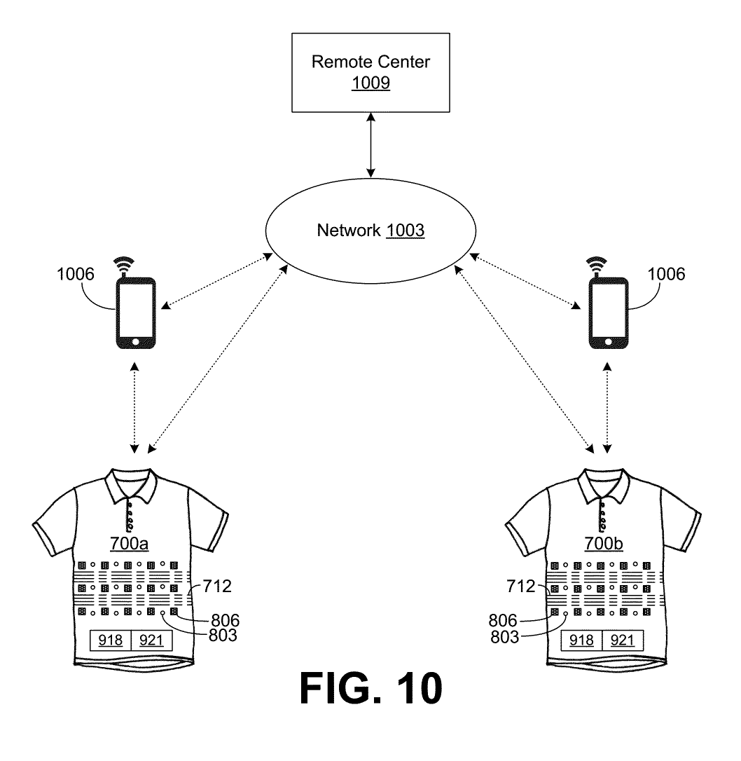

Referring next to FIG. 10, shown is an example of a system utilizing a plurality of wearables or garments 700 (e.g., shirt, shorts, pants or other form of clothing) with integrated information infrastructures including actuators for the communication of physical interactions between the wearers. As shown in FIG. 10, the system can include a first garment 700a with an integrated information infrastructure including a plurality of sensors 803 (e.g., accelerometers and piezoelectric sensors) configured to detect or sense physical interactions such as impacts, accelerations, or other tactile stimulations experienced by the wearer of the first garment 700a. Signals can be communicated from the sensors 803 to one or more multi-functional processor 918, where they can be processed or evaluated to determine the type of physical impact being experienced by the wearer of the first garment 700a.

The sensor information can be wirelessly transmitted by the processor 918 via a transceiver 921 (or transmitter) to a network 1003. As illustrated in FIG. 10, the transceiver 921 can establish a Bluetooth® link with a smart mobile communications device 1006 such as, e.g., a smart-phone and/or tablet, which can retransmit the information through a cellular data link or a Wi-Fi link. In other implementations, the transceiver 921 can be configured to establish a Wi-Fi link with an access point or gateway of the network 1003 (e.g., a wireless local area network (WLAN)) for the transmission of the sensor information. In some embodiments, the transceiver 921 can establish a cellular data link for the transmission of the sensor information with the network 1003 (e.g., a cellular network).

In some cases, the processor 918 can physically interface (e.g., through a detachable connection) with processing and/or communication circuitry in a vehicle, couch or chair in which the individual wearing the first garment 700a is located. For instance, a race car driver can connect the information infrastructure in the garment 700a to circuitry (e.g., processor, memory, transceiver, etc.) integrated in the race car. The sensor information can then be communicated from the first garment 700a via the transceiver in the race car. In addition, power for the integrated information infrastructure can be provided wirelessly to the first garment 700a through primary circuitry in the seat of the driver and secondary circuitry integrated into the first garment 700a.

In some implementations, the sensor information can be sent, via the network 1003, to a remotely located monitoring center 1009 (e.g., a command and control center for first responders or for a crew chief of a racing team) where it can be processed, monitored and/or evaluated to determine physical conditions experienced by the wearer of the first garment 700a. In other implementations, the sensor information can be sent, via the network 1003, to a second garment 700b with an integrated information infrastructure including a plurality of actuation fibers 712 and/or actuators 806 (e.g., piezoelectric devices and/or electromechanical devices). The network 1003 can include a combination of networks (e.g., cellular, WLAN, Internet, etc.) that facilitate the communication of sensor information from the first garment 700a to the monitoring center 1009 and/or second garment 700b.

The sensor information can be wirelessly received by the second garment 700b via a transceiver 921 (or receiver) from the network 1003. As illustrated in FIG. 10, the transceiver 921 can receive the information through a Bluetooth® link with a smart mobile communications device 1006 with a link to the network 1003. An application on the smart mobile device 1006 can be used to interface with the integrated information infrastructure of one or more garment 700, another smart mobile device 1006, and/or with a remotely located monitoring center 1009. In other implementations, the transceiver 921 can be configured to establish a Wi-Fi link or a cellular data link with the network 1003. The received sensor information can be processed by one or more processor 918 to control the actuation fibers 712 and/or actuators 806 in the second garment 700b to simulate the tactile stimulations felt by the wearer of the first garment 700a. The processor 918 can process the sensor information to determine the appropriate combination of actuation fibers 712 and/or actuators 806 to simulate the sensed physical interaction. For example, specific actuation devices can be identified to simulate an impact experienced by the first garment. In addition, an appropriate sequence of activation can be determined for the actuators. As in the case of a race car driver or football player, a fan can “feel” the forces and impacts felt by the driver or player during the sporting event. In some cases, the sensor information can be received by multiple garments 700, which can then provide corresponding physical stimulations to the wearers of those garments.

In some applications, the garments 700 can be configured to facilitate communications between the wearers through tactile stimulations. For example, if the wearer of the second garment 700b taps himself on the right side of the abdomen, indications of this impact can be communicated by the integrated information infrastructure to the first garment 700a, which can then produce a physical impact at approximately the same location on the wearer of the first garment 700a. If this signal has a meaning know to both wearers, then the information has been physically communicated between them. As can be understood, a series of taps can be used to communicate information to the receiver (e.g., signals from a coach to a hitter in baseball) and two-way conversations can be carried out in this manner without uttering a word.

Similarly, the sensor information can be communicated from the first garment 700a to the remotely located monitoring center 1009, where it can be processed and/or stored for later evaluation. In some cases, real-time monitoring can be carried out during an activity of the individual wearing the first garment 700a. For example, ambient conditions felt by the wearer (e.g., temperature, moisture, illumination levels, etc.) can be sensed by various sensing elements 803 connected to the integrated information infrastructure, and transmitted to the monitoring center 1009. Physical interactions experienced by the wearer, as well as his bodily movement, can also be communicated to the monitoring center 1009.

This information can be used in multiple ways. For example, the condition and safety of first responders in a hazardous situation can be tracked. If the sensor information indicates an abnormal or unacceptable condition, then the monitoring center 1009 can communicate with the first responder (e.g., through tactile stimulation via the actuators 806 in the first garment 700a) or direct others to the aid of the wearer of the first garment 700a. Another example is where body movement of an athlete is tracked. In this case, the first garment 700a can provide tactile feedback to the wearer is the motion deviates from the desired actions. For example, in the same way a coach can reposition a player with taps and pressure, pulses and/or pressure can be applied through the actuators 803 to indicated proper arm position and/or motion for the swing of a golfer or baseball player. This can help train the individual to have a consistent swing (or other motion) through repetition with automatic feedback to correct for variations.

In one embodiment, among others, a system is provided comprising a first garment having an integrated information infrastructure including a plurality of sensors distributed about the first garment and a second garment having an integrated information infrastructure including a plurality of actuation devices distributed about the second garment. The first garment can be configured to transmit sensor information corresponding to a physical stimulation experienced by a wearer of the first garment and the second garment can be configured to receive the sensor information from the first garment and control the plurality of actuation devices to provide a corresponding physical stimulation to a wearer of the second garment.

In any one or more aspects of the system, the sensor information can be transmitted by the first garment via a wireless link. The integrated information infrastructure of the first garment can comprise a wireless transceiver for transmission of the sensor information via the wireless link. In various embodiments, the system can comprise a smart mobile communications device in communication with the wireless transceiver. The smart mobile communications device can be configured to receive the sensor information via the wireless link and transmit the sensor information to the second garment via a second wireless link. The second wireless link can be a cellular data link with a network. In any one or more aspects of the system, the first garment can be configured to transmit the sensor information to a remotely located monitoring center.

In any one or more aspects of the system, the sensor information can be received by the second garment via a wireless link. The integrated information infrastructure of the second garment can comprise a wireless transceiver for receipt of the sensor information via the wireless link. In various embodiments, the system can comprise a smart mobile communications device in communication with the wireless transceiver. The smart mobile communications device can be configured to receive the sensor information transmitted by the first garment and transmit the sensor information to the wireless transceiver via the wireless link. The smart mobile communications device can receive the sensor information via a second wireless link with a network. The second wireless link can be a cellular data link.

In any one or more aspects of the system, the plurality of sensors can comprise accelerometers configured to sense an acceleration caused by the physical stimulation experienced by the first wearer. The plurality of sensors can comprise piezoelectric sensors configured to sense a distortion caused by the physical stimulation experienced by the first wearer. In any one or more aspects of the system, the plurality of actuation devices comprises actuation fibers distributed about a portion of the second garment and/or piezoelectric actuators distributed about the second garment. The actuation fibers can be configured to contract to provide the corresponding physical stimulation to the second wearer. For example, the actuation fibers can be distributed on a right side or a left side of the second garment. The piezoelectric actuators can be configured to distort to provide the corresponding physical stimulation to the second wearer. The piezoelectric actuators can be distributed in an array.

In any one or more aspects of the system, the integrated information infrastructure of the second garment can include a plurality of sensors distributed about the second garment. The second garment can be configured to transmit sensor information corresponding to a physical stimulation experienced by the second wearer of the second garment. The integrated information infrastructure of the first garment can include a plurality of actuation devices distributed about the first garment. The first garment can be configured to receive the sensor information from the second garment and control the plurality of actuation devices to provide a corresponding physical stimulation to the first wearer of the first garment.

In another embodiment, a method is provided that comprises receiving, by a first garment having an integrated information infrastructure, sensor information received from a second garment having an integrated information infrastructure including a plurality of sensors, the sensor information corresponding to a physical interaction sensed by at least a portion of the plurality of sensors. The method further comprises controlling one or more actuation devices distributed about the first garment to provide a corresponding physical stimulation to a wearer of the first garment. The method can further comprise identifying, based upon the sensor information received from the second garment, the one or more actuation device from a plurality of actuation devices distributed about the first garment.

In any one or more aspects of the method, the sensor information can be received by the first garment via a smart mobile communications device that is wirelessly linked to the first garment. The smart mobile communications device can be wirelessly linked to a transceiver of the first garment via a Bluetooth® link. The smart mobile communications device can receive the sensor information from another smart mobile communications device in communication with the second garment.

In any one or more aspects of the method, the one or more actuation device can comprise actuation fibers distributed about a portion of the first garment, the actuation fibers configured to contract to provide the corresponding physical stimulation to the wearer of the first garment. In any one or more aspects of the method, the one or more actuation device can comprise one or more piezoelectric actuator distributed about the first garment, the piezoelectric actuators configured to distort to provide the corresponding physical stimulation to the wearer of the first garment.

In any one or more aspects of the method, the method can further comprise detecting, by one or more sensor distributed about the first garment, a physical interaction with the first garment, and transmitting sensor information associated with the physical interaction with the first garment. The one or more sensor can comprise one or more accelerometer configured to sense an acceleration caused by the physical interaction and/or one or more piezoelectric sensors configured to sense a distortion caused by the physical interaction. The sensor information associated with the physical interaction can be transmitted via a smart mobile communications device that is wirelessly linked to the first garment.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A system, comprising:
a first garment having an integrated information infrastructure including a plurality of sensors distributed about the first garment, the first garment configured to transmit sensor information corresponding to a physical stimulation experienced by a first wearer of the first garment; and
a second garment having an integrated information infrastructure including a plurality of actuation devices distributed about the second garment, the second garment configured to receive the sensor information from the first garment and control the plurality of actuation devices to provide a corresponding physical stimulation to a second wearer of the second garment.

2. The system of claim 1, wherein the sensor information is transmitted by the first garment via a wireless link.

3. The system of claim 2, wherein the integrated information infrastructure of the first garment comprises a wireless transceiver for transmission of the sensor information via the wireless link.

4. The system of claim 3, comprising a smart mobile communications device in communication with the wireless transceiver, the smart mobile communications device configured to receive the sensor information via the wireless link and transmit the sensor information to the second garment via a second wireless link.

5. The system of claim 4, wherein the second wireless link is a cellular data link with a network.

6. The system of claim 1, wherein the integrated information infrastructure of the second garment comprises a wireless transceiver configured to receive the sensor information via the wireless link.

7. The system of claim 6, comprising a smart mobile communications device in communication with the wireless transceiver, the smart mobile communications device configured to receive the sensor information transmitted by the first garment and transmit the sensor information to the wireless transceiver via the wireless link.

8. The system of claim 7, wherein the smart mobile communications device receives the sensor information via a second wireless link with a network.

9. The system of claim 1, wherein the plurality of sensors comprises accelerometers configured to sense an acceleration caused by the physical stimulation experienced by the first wearer or piezoelectric sensors configured to sense a distortion caused by the physical stimulation experienced by the first wearer.

10. The system of claim 1, wherein the first garment is further configured to transmit the sensor information to a remotely located monitoring center.

11. The system of claim 1, wherein the plurality of actuation devices comprises actuation fibers distributed about a portion of the second garment, the actuation fibers configured to contract to provide the corresponding physical stimulation to the second wearer, or piezoelectric actuators distributed about the second garment, the piezoelectric actuators configured to distort to provide the corresponding physical stimulation to the second wearer.

12. The system of claim 11, wherein the actuation fibers are distributed about the abdomen section of the second garment, on a right side of the garment, or a left side of the garment.

13. The system of claim 11, wherein the piezoelectric actuators are distributed in an array.

14. The system of claim 1, wherein the integrated information infrastructure of the second garment includes a plurality of sensors distributed about the second garment, the second garment configured to transmit sensor information corresponding to a physical stimulation experienced by the second wearer of the second garment.

15. The system of claim 14, wherein the integrated information infrastructure of the first garment includes a plurality of actuation devices distributed about the first garment, the first garment configured to receive the sensor information from the second garment and control the plurality of actuation devices to provide a corresponding physical stimulation to the first wearer of the first garment.

16. A method, comprising:
receiving, by a first garment having an integrated information infrastructure, sensor information received from a second garment having an integrated information infrastructure including a plurality of sensors, the sensor information corresponding to a physical interaction sensed by at least a portion of the plurality of sensors; and
controlling one or more actuation device distributed about the first garment to provide a corresponding physical stimulation to a wearer of the first garment. The method of claim 16, further comprising identifying, based upon the sensor information received from the second garment, the one or more actuation device from a plurality of actuation devices distributed about the first garment.

18. The method of claim 16, wherein the sensor information is received by the first garment via a smart mobile communications device that is wirelessly linked to the first garment.

19. The method of claims 16, further comprising:
detecting, by one or more sensor distributed about the first garment, a physical interaction with the first garment; and
transmitting sensor information associated with the physical interaction with the first garment.

20. The method of claim 19, wherein the sensor information associated with the physical interaction is transmitted via a smart mobile communications device that is wirelessly linked to the first garment.
